(19) United States
(12) Patent Application Publication
(10) Pub. No.: US 2014/0160029 A1
(43) Pub. Date: Jun. 12, 2014

(54) Systems and Methods for a Trackpad Within a Keyboard

(71) Applicants: Jenny Yuen, Cambridge, MA (US); Luke St.Clair, Redmond, WA (US)

(72) Inventors: Jenny Yuen, Cambridge, MA (US); Luke St.Clair, Redmond, WA (US)

(21) Appl. No.: 13/707,220

(22) Filed: Dec. 6, 2012

(51) Int. Cl. G06F 3/041

(52) U.S. Cl. CPC G06F 3/0412
USPC 345/169

(57) ABSTRACT

In one embodiment, a method includes providing for display to a user a set of keys within a region of a touch-screen user interface, each key being responsive to a keystroke touch-gesture within an area of the key. The method also includes receiving a pre-defined user input other than a keystroke touch-gesture within an area of a key. The method further includes, in response to the pre-defined user input, providing within the region of the touch-screen user interface a trackpad in place of at least a portion of the set of keys.

### TECHNICAL FIELD

This disclosure generally relates to systems and methods for providing for input to a computer system, including providing for input to a mobile computing and/or communication system using an input device having an electronic visual display, such as a touch screen, and further providing for input to the computer system using a trackpad within a keyboard.

### BACKGROUND

Mobile computing and communication devices, such as cellphones, PDAs, tablet computers, and mini-laptops, are widely used to perform a variety of computing and communication tasks. Computing devices can include one or more input devices to receive input from a user, including a keyboard, pointing device, microphone, camera, or other suitable input device. Some computing devices can allow a user to provide input on an electronic visual display, such as a touch screen. In this manner, a user can provide input by touching a certain portions of the electronic visual display corresponding to a desired input. Mobile computing devices may also execute software applications, such as games, web browsers, or social-networking applications. With social-networking applications, users may connect, communicate, and share information with other users in their social networks.

### SUMMARY OF PARTICULAR EMBODIMENTS

The purpose and advantages of the disclosed subject matter will be set forth in and apparent from the description that follows, as well as will be learned by practice of the disclosed subject matter. Additional advantages of the disclosed subject matter will be realized and attained by the methods and systems particularly pointed out in the written description and claims hereof, as well as from the appended drawings.

To achieve these and other advantages and in accordance with the purpose of the disclosed subject matter, as embodied and broadly described, the disclosed subject matter is related to a method including providing for display to a user a set of keys within a region of a touch-screen user interface, each key being responsive to a keystroke touch-gesture within an area of the key, receiving a pre-defined user input other than a keystroke touch-gesture within an area of a key, and, in response to the pre-defined user input, providing within the region of the touch-screen user interface a trackpad in place of at least a portion of the set of keys.

For example and as embodied herein, such a method may allow a personal computing device to provide a trackpad within a keyboard when the user has provided an indication that they would like to utilize a trackpad. As such, a user may not be required to provide touch-gestures in the content portion of the personal computing device (which may cause unintended results, such as accidentally selecting a portion of the content instead of scrolling through the content as was intended by the user) in order to change the content. Instead, the user may utilize the trackpad to change the content.

In some embodiments, a trackpad may include any input device that translates a motion and/or position of a user's finger (or other object) to a relative position on the touch-screen. For example, if the user touches the trackpad and moves their finger upward, content being viewed in a content portion may scroll up (or vice versa). In some embodiments, the trackpad may also allow a user to input data. For example, the user may draw a circle on the trackpad, resulting in a smiley face being input into the content portion. In some embodiments, the trackpad may be provided in place of at least a portion of a set of keys (such as a portion of keys of a virtual keyboard). For example, the trackpad may be provided in place of the “f” key, the “g” key, the “h” key, the “c” key, the “v” key and the “b” key of a QWERTY keyboard. In some embodiments, although the trackpad may be provided in place of at least a portion of a set of keys (such as a portion of keys of a virtual keyboard), the trackpad may not be displayed. For example, even though the trackpad may be provided in place of the “f” key, the “g” key, the “h” key, the “c” key, the “v” key and the “b” key, each of these keys may still be displayed to the user. However, these keys may now operate as a trackpad instead of individual keys. In some embodiments, the trackpad may be provided for display in place of at least a portion of a set of keys (such as a portion of a set of keys of a virtual keyboard). For example, the trackpad may be provided for display in place of the “f” key, the “g” key, the “h” key, the “c” key, the “v” key and the “b” key. As such, a display of the trackpad may replace these keys. In such an example, the trackpad may be displayed as any suitable graphical representation (such as a blank screen, a knob icon, a slider icon, etc.). Furthermore, the displayed trackpad may have any suitable size, suitable shape, suitable position in the keyboard, or any combination of the preceding.

In some embodiments, the trackpad may be provided in response to a pre-defined user input other than a keystroke touch-gesture within an area of a key. Such a pre-defined user input may include any input that does not indicate that the user intends to input a symbol corresponding a particular key, such as a swiping gesture, a dragging gesture, a pinching gesture, a gesture that includes the user touching more than one of the keys in the set of keys at the same time or approximately the same time (such as the user pressing the “q” key, the “w” key, and the “e” key at the same time or at approximately the same time (such as within a range of time that indicates that the user is not intending to input two or more different symbols)), a gesture that changes the orientation of the personal computing device (such as turning the personal computing device from a vertical orientation to a horizontal orientation, rotating the personal computing device, making a gesture with the personal computing device, etc.), any other pre-defined user input that does not indicate that a user intends to input a symbol corresponding to a particular key, or any combination of the preceding.

The disclosed subject matter is also related to one or more computer-readable non-transitory storage media embodying software that is operable when executed to: provide for display to a user a set of keys within a region of a touch-screen user interface, each key being responsive to a keystroke touch-gesture within an area of the key, receive a pre-defined user input other than a keystroke touch-gesture within an area of a key, and, in response to the pre-defined user input, provide within the region of the touch-screen user interface a trackpad in place of at least a portion of the set of keys.

The disclosed subject matter is further related to a system including one or more processors and a memory coupled to the processors. The memory includes instructions executable by the processors. The processors are operable when executing the instructions to: provide for display to a user a set of keys within a region of a touch-screen user interface, each key being responsive to a keystroke touch-gesture within an area of the key, receive a pre-defined user input other than a keystroke touch-gesture within an area of a key, and, in response to the pre-defined user input, provide within the region of the touch-screen user interface a trackpad in place of at least a portion of the set of keys.

### BRIEF DESCRIPTION OF THE DRAWINGS

FIG. 1 illustrates an example network environment associated with a social-networking system.

FIG. 2 illustrates an example social graph.

FIG. 3 illustrates an example personal computing device.

FIG. 4 illustrates an example scenario in which a user provides input to a personal computing device.

FIG. 5 illustrates a virtual keyboard that includes a trackpad in place of a portion of the keys.

FIG. 6 illustrates an exemplary method for providing a trackpad within a keyboard.

FIG. 7 illustrates an example computer system.

### DESCRIPTION OF EXAMPLE EMBODIMENTS

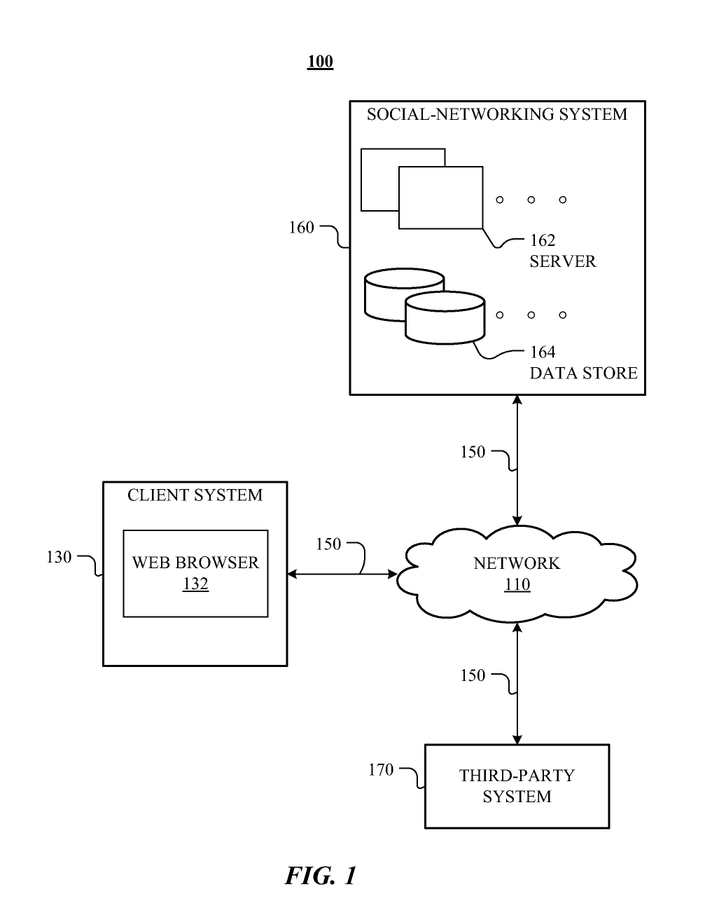

FIG. 1 illustrates an example network environment 100 associated with a social-networking system. Network environment 100 includes a client system 130, a social-networking system 160, and a third-party system 170 connected to each other by a network 110. Although FIG. 1 illustrates a particular arrangement of client system 130, social-networking system 160, third-party system 170, and network 110, this disclosure contemplates any suitable arrangement of client system 130, social-networking system 160, third-party system 170, and network 110. As an example and not by way of limitation, two or more of client system 130, social-networking system 160, and third-party system 170 may be connected to each other directly, bypassing network 110. As another example, two or more of client system 130, social-networking system 160, and third-party system 170 may be physically or logically co-located with each other in whole or in part. Moreover, although FIG. 1 illustrates a particular number of client systems 130, social-networking systems 160, third-party systems 170, and networks 110, this disclosure contemplates any suitable number of client systems 130, social-networking systems 160, third-party systems 170, and networks 110. As an example and not by way of limitation, network environment 100 may include multiple client system 130, social-networking systems 160, third-party systems 170, and networks 110.

This disclosure contemplates any suitable network 110. As an example and not by way of limitation, one or more portions of network 110 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. Network 110 may include one or more networks 110.

Links 150 may connect client system 130, social-networking system 160, and third-party system 170 to communication network 110 or to each other. This disclosure contemplates any suitable links 150. In particular embodiments, one or more links 150 include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links 150 each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 150, or a combination of two or more such links 150. Links 150 need not necessarily be the same throughout network environment 100. One or more first links 150 may differ in one or more respects from one or more second links 150.

In particular embodiments, client system 130 may be an electronic device including hardware, software, or embedded logic components or a combination of two or more such components and capable of carrying out the appropriate functionalities implemented or supported by client system 130. As an example and not by way of limitation, a client system 130 may include a computer system such as a desktop computer, notebook or laptop computer, netbook, a tablet computer, e-book reader, GPS device, camera, personal digital assistant (PDA), handheld electronic device, cellular telephone, smartphone, other suitable electronic device, or any suitable combination thereof. This disclosure contemplates any suitable client systems 130. A client system 130 may enable a network user at client system 130 to access network 110. A client system 130 may enable its user to communicate with other users at other client systems 130.

In particular embodiments, client system 130 may include a web browser 132, such as MICROSOFT INTERNET EXPLORER, GOOGLE CHROME or MOZILLA FIREFOX, and may have one or more add-ons, plug-ins, or other extensions, such as TOOLBAR or YAHOO TOOLBAR. A user at client system 130 may enter a Uniform Resource Locator (URL) or other address directing the web browser 132 to a particular server (such as server 162, or a server associated with a third-party system 170), and the web browser 132 may generate a Hyper Text Transfer Protocol (HTTP) request and communicate the HTTP request to server. The server may accept the HTTP request and communicate to client system 130 one or more Hyper Text Markup Language (HTML) files responsive to the HTTP request. Client system 130 may render a webpage based on the HTML files from the server for presentation to the user. This disclosure contemplates any suitable webpage files. As an example and not by way of limitation, webpages may render from HTML files, Extensible Hyper Text Markup Language (XHTML) files, or Extensible Markup Language (XML) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a webpage encompasses one or more corresponding webpage files (which a browser may use to render the webpage) and vice versa, where appropriate.

In particular embodiments, social-networking system 160 may be a network-addressable computing system that can host an online social network. Social-networking system 160 may generate, store, receive, and send social-networking data, such as, for example, user-profile data, concept-profile data, social-graph information, or other suitable data related to the online social network. Social-networking system 160 may be accessed by the other components of network environment 100 either directly or via network 110. In particular embodiments, social-networking system 160 may include one or more servers 162. Each server 162 may be a unitary server or a distributed server spanning multiple computers or multiple datacenters. Servers 162 may be of various types, such as, for example and without limitation, web server, news server, mail server, message server, advertising server, file server, application server, exchange server, database server, proxy server, another server suitable for performing functions or processes described herein, or any combination thereof In particular embodiments, each server 162 may include hardware, software, or embedded logic components or a combination of two or more such components for carrying out the appropriate functionalities implemented or supported by server 162. In particular embodiments, social-networking system 164 may include one or more data stores 164. Data stores 164 may be used to store various types of information. In particular embodiments, the information stored in data stores 164 may be organized according to specific data structures. In particular embodiments, each data store 164 may be a relational, columnar, correlation, or other suitable database. Although this disclosure describes or illustrates particular types of databases, this disclosure contemplates any suitable types of databases. Particular embodiments may provide interfaces that enable a client system 130, a social-networking system 160, or a third-party system 170 to manage, retrieve, modify, add, or delete, the information stored in data store 164.

In particular embodiments, social-networking system 160 may store one or more social graphs in one or more data stores 164. In particular embodiments, a social graph may include multiple nodes—which may include multiple user nodes (each corresponding to a particular user) or multiple concept nodes (each corresponding to a particular concept)—and multiple edges connecting the nodes. Social-networking system 160 may provide users of the online social network the ability to communicate and interact with other users. In particular embodiments, users may join the online social network via social-networking system 160 and then add connections (e.g. relationships) to a number of other users of social-networking system 160 whom they want to be connected to. Herein, the term “friend” may refer to any other user of social-networking system 160 with whom a user has formed a connection, association, or relationship via social-networking system 160.

In addition to interactions with other users, the social-networking system 160 provides users with the ability to perform various types of activities with social networking objects supported by the system. A social networking object can represent a variety of things, including, without limitation, profiles, applications (e.g., games playable within the social networking system), events (e.g., a page representative of a concert that users may attend), groups (e.g., a page to which user may belong), entity based pages or hubs (e.g., a page constituting a particular entity's presence on the social networking system), locations associated with a user (e.g., “Palo Alto, Calif., USA”), advertisements (e.g., a page including advertising content), user-generated content items (e.g., user posts), representations of physical or digital items, concepts, etc. A user can interact with a social networking object by associating with the object or performing an action on the object. For example, a user can interact with an object by joining a group, attending an event, checking-in to a location, becoming a fan of an organization's fan page, “liking” a fan page, posting to a fan page, etc. These are just a few examples of the objects upon which a user may act on in a social networking system, and many others are possible.

In particular embodiments, social-networking system 160 may provide users with the ability to take actions on various types of items or objects, supported by social-networking system 160. As an example and not by way of limitation, the items and objects may include groups or social networks to which users of social-networking system 160 may belong, events or calendar entries in which a user might be interested, computer-based applications that a user may use, transactions that allow users to buy or sell items via the service, interactions with advertisements that a user may perform, or other suitable items or objects. A user may interact with anything that is capable of being represented in social-networking system 160 or by an external system of third-party system 170, which is separate from social-networking system 160 and coupled to social-networking system 160 via a network 110.

In particular embodiments, social-networking system 160 may be capable of linking a variety of entities. As an example and not by way of limitation, social-networking system 160 may enable users to interact with each other as well as receive content from third-party systems 170 or other entities, or to allow users to interact with these entities through an application programming interfaces (API) or other communication channels.

In particular embodiments, a third-party system 170 may include one or more types of servers, one or more data stores, one or more interfaces, including but not limited to APIs, one or more web services, one or more content sources, one or more networks, or any other suitable components, e.g., that servers may communicate with. A third-party system 170 may be operated by a different entity from an entity operating social-networking system 160. In particular embodiments, however, social-networking system 160 and third-party systems 170 may operate in conjunction with each other to provide social-networking services to users of social-networking system 160 or third-party systems 170. In this sense, social-networking system 160 may provide a platform, or backbone, which other systems, such as third-party systems 170, may use to provide social-networking services and functionality to users across the Internet.

In particular embodiments, a third-party system 170 may include a third-party content object provider. A third-party content object provider may include one or more sources of content objects, which may be communicated to a client system 130. As an example and not by way of limitation, content objects may include information regarding things or activities of interest to the user, such as, for example, movie show times, movie reviews, restaurant reviews, restaurant menus, product information and reviews, or other suitable information. As another example and not by way of limitation, content objects may include incentive content objects, such as coupons, discount tickets, gift certificates, or other suitable incentive objects.

In particular embodiments, social-networking system 160 also includes user-generated content objects, which may enhance a user's interactions with social-networking system 160. User-generated content may include anything a user can add, upload, send, or “post” to social-networking system 160. As an example and not by way of limitation, a user communicates posts to social-networking system 160 from a client system 130. Posts may include data such as status updates or other textual data, location information, photos, videos, links, music or other similar data or media. Content may also be added to social-networking system 160 by a third-party through a “communication channel,” such as a newsfeed or stream.

In particular embodiments, social-networking system 160 may include a variety of servers, sub-systems, programs, modules, logs, and data stores. In particular embodiments, social-networking system 160 may include one or more of the following: a web server, action logger, API-request server, relevance-and-ranking engine, content-object classifier, notification controller, action log, third-party-content-object-exposure log, inference module, authorization/privacy server, search module, advertisement-targeting module, user-interface module, user-profile store, connection store, third-party content store, or location store. Social-networking system 160 may also include suitable components such as network interfaces, security mechanisms, load balancers, failover servers, management-and-network-operations consoles, other suitable components, or any suitable combination thereof. In particular embodiments, social-networking system 160 may include one or more user-profile stores for storing user profiles. A user profile may include, for example, biographic information, demographic information, behavioral information, social information, or other types of descriptive information, such as work experience, educational history, hobbies or preferences, interests, affinities, or location. Interest information may include interests related to one or more categories. Categories may be general or specific. As an example and not by way of limitation, if a user “likes” an article about a brand of shoes the category may be the brand, or the general category of “shoes” or “clothing.” A connection store may be used for storing connection information about users. The connection information may indicate users who have similar or common work experience, group memberships, hobbies, educational history, or are in any way related or share common attributes. The connection information may also include user-defined connections between different users and content (both internal and external). A web server may be used for linking social-networking system 160 to one or more client systems 130 or one or more third-party system 170 via network 110. The web server may include a mail server or other messaging functionality for receiving and routing messages between social-networking system 160 and one or more client systems 130. An API-request server may allow a third-party system 170 to access information from social-networking system 160 by calling one or more APIs. An action logger may be used to receive communications from a web server about a user's actions on or off social-networking system 160. In conjunction with the action log, a third-party-content-object log may be maintained of user exposures to third-party-content objects. A notification controller may provide information regarding content objects to a client system 130. Information may be pushed to a client system 130 as notifications, or information may be pulled from client system 130 responsive to a request received from client system 130. Authorization servers may be used to enforce one or more privacy settings of the users of social-networking system 160. A privacy setting of a user determines how particular information associated with a user can be shared. The authorization server may allow users to opt in or opt out of having their actions logged by social-networking system 160 or shared with other systems (e.g. third-party system 170), such as, for example, by setting appropriate privacy settings. Third-party-content-object stores may be used to store content objects received from third parties, such as a third-party system 170. Location stores may be used for storing location information received from client systems 130 associated with users. Advertisement-pricing modules may combine social information, the current time, location information, or other suitable information to provide relevant advertisements, in the form of notifications, to a user.

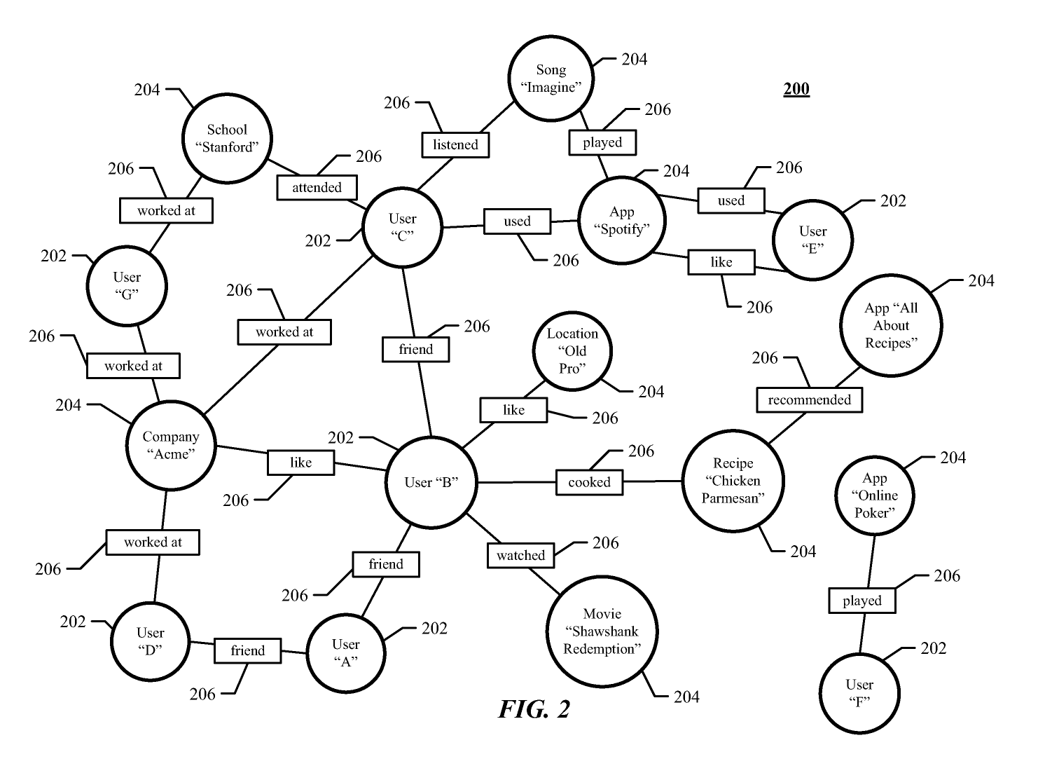

FIG. 2 illustrates example social graph 200. In particular embodiments, social-networking system 160 may store one or more social graphs 200 in one or more data stores. In particular embodiments, social graph 200 may include multiple nodes—which may include multiple user nodes 202 or multiple concept nodes 204—and multiple edges 206 connecting the nodes. Example social graph 200 illustrated in FIG. 2 is shown, for didactic purposes, in a two-dimensional visual map representation. In particular embodiments, a social-networking system 160, client system 130, or third-party system 170 may access social graph 200 and related social-graph information for suitable applications. The nodes and edges of social graph 200 may be stored as data objects, for example, in a data store (such as a social-graph database). Such a data store may include one or more searchable or queryable indexes of nodes or edges of social graph 200.

In particular embodiments, a user node 202 may correspond to a user of social-networking system 160. As an example and not by way of limitation, a user may be an individual (human user), an entity (e.g. an enterprise, business, or third-party application), or a group (e.g. of individuals or entities) that interacts or communicates with or over social-networking system 160. In particular embodiments, when a user registers for an account with social-networking system 160, social-networking system 160 may create a user node 202 corresponding to the user, and store the user node 202 in one or more data stores. Users and user nodes 202 described herein may, where appropriate, refer to registered users and user nodes 202 associated with registered users. In addition or as an alternative, users and user nodes 202 described herein may, where appropriate, refer to users that have not registered with social-networking system 160. In particular embodiments, a user node 202 may be associated with information provided by a user or information gathered by various systems, including social-networking system 160. As an example and not by way of limitation, a user may provide his or her name, profile picture, contact information, birth date, sex, marital status, family status, employment, education background, preferences, interests, or other demographic information. In particular embodiments, a user node 202 may be associated with one or more data objects corresponding to information associated with a user. In particular embodiments, a user node 202 may correspond to one or more webpages.

In particular embodiments, a concept node 204 may correspond to a concept. As an example and not by way of limitation, a concept may correspond to a place (such as, for example, a movie theater, restaurant, landmark, or city); a website (such as, for example, a website associated with social-network system 160 or a third-party website associated with a web-application server); an entity (such as, for example, a person, business, group, sports team, or celebrity); a resource (such as, for example, an audio file, video file, digital photo, text file, structured document, or application) which may be located within social-networking system 160 or on an external server, such as a web-application server; real or intellectual property (such as, for example, a sculpture, painting, movie, game, song, idea, photograph, or written work); a game; an activity; an idea or theory; another suitable concept; or two or more such concepts. A concept node 204 may be associated with information of a concept provided by a user or information gathered by various systems, including social-networking system 160. As an example and not by way of limitation, information of a concept may include a name or a title; one or more images (e.g. an image of the cover page of a book); a location (e.g. an address or a geographical location); a website (which may be associated with a URL); contact information (e.g. a phone number or an email address); other suitable concept information; or any suitable combination of such information. In particular embodiments, a concept node 204 may be associated with one or more data objects corresponding to information associated with concept node 204. In particular embodiments, a concept node 204 may correspond to one or more webpages.

In particular embodiments, a node in social graph 200 may represent or be represented by a webpage (which may be referred to as a “profile page”). Profile pages may be hosted by or accessible to social-networking system 160. Profile pages may also be hosted on third-party websites associated with a third-party server 170. As an example and not by way of limitation, a profile page corresponding to a particular external webpage may be the particular external webpage and the profile page may correspond to a particular concept node 204. Profile pages may be viewable by all or a selected subset of other users. As an example and not by way of limitation, a user node 202 may have a corresponding user-profile page in which the corresponding user may add content, make declarations, or otherwise express himself or herself. As another example and not by way of limitation, a concept node 204 may have a corresponding concept-profile page in which one or more users may add content, make declarations, or express themselves, particularly in relation to the concept corresponding to concept node 204.

In particular embodiments, a concept node 204 may represent a third-party webpage or resource hosted by a third-party system 170. The third-party webpage or resource may include, among other elements, content, a selectable or other icon, or other inter-actable object (which may be implemented, for example, in JavaScript, AJAX, or PHP codes) representing an action or activity. As an example and not by way of limitation, a third-party webpage may include a selectable icon such as “like,” “check in,” “eat,” “recommend,” or another suitable action or activity. A user viewing the third-party webpage may perform an action by selecting one of the icons (e.g. “eat”), causing a client system 130 to send to social-networking system 160 a message indicating the user's action. In response to the message, social-networking system 160 may create an edge (e.g. an “eat” edge) between a user node 202 corresponding to the user and a concept node 204 corresponding to the third-party webpage or resource and store edge 206 in one or more data stores.

In particular embodiments, a pair of nodes in social graph 200 may be connected to each other by one or more edges 206. An edge 206 connecting a pair of nodes may represent a relationship between the pair of nodes. In particular embodiments, an edge 206 may include or represent one or more data objects or attributes corresponding to the relationship between a pair of nodes. As an example and not by way of limitation, a first user may indicate that a second user is a “friend” of the first user. In response to this indication, social-networking system 160 may send a “friend request” to the second user. If the second user confirms the “friend request,” social-networking system 160 may create an edge 206 connecting the first user's user node 202 to the second user's user node 202 in social graph 200 and store edge 206 as social-graph information in one or more of data stores 24. In the example of FIG. 2, social graph 200 includes an edge 206 indicating a friend relation between user nodes 202 of user “A” and user “B” and an edge indicating a friend relation between user nodes 202 of user “C” and user “B.” Although this disclosure describes or illustrates particular edges 206 with particular attributes connecting particular user nodes 202, this disclosure contemplates any suitable edges 206 with any suitable attributes connecting user nodes 202. As an example and not by way of limitation, an edge 206 may represent a friendship, family relationship, business or employment relationship, fan relationship, follower relationship, visitor relationship, subscriber relationship, superior/subordinate relationship, reciprocal relationship, non-reciprocal relationship, another suitable type of relationship, or two or more such relationships. Moreover, although this disclosure generally describes nodes as being connected, this disclosure also describes users or concepts as being connected. Herein, references to users or concepts being connected may, where appropriate, refer to the nodes corresponding to those users or concepts being connected in social graph 200 by one or more edges 206.

In particular embodiments, an edge 206 between a user node 202 and a concept node 204 may represent a particular action or activity performed by a user associated with user node 202 toward a concept associated with a concept node 204. As an example and not by way of limitation, as illustrated in FIG. 2, a user may “like,” “attended,” “played,” “listened,” “cooked,” “worked at,” or “watched” a concept, each of which may correspond to a edge type or subtype. A concept-profile page corresponding to a concept node 204 may include, for example, a selectable “check in” icon (such as, for example, a clickable “check in” icon) or a selectable “add to favorites” icon. Similarly, after a user clicks these icons, social-networking system 160 may create a “favorite” edge or a “check in” edge in response to a user's action corresponding to a respective action. As another example and not by way of limitation, a user (user “C”) may listen to a particular song (“Ramble On”) using a particular application (SPOTIFY, which is an online music application). In this case, social-networking system 160 may create a “listened” edge 206 and a “used” edge (as illustrated in FIG. 2) between user nodes 202 corresponding to the user and concept nodes 204 corresponding to the song and application to indicate that the user listened to the song and used the application. Moreover, social-networking system 160 may create a “played” edge 206 (as illustrated in FIG. 2) between concept nodes 204 corresponding to the song and the application to indicate that the particular song was played by the particular application. In this case, “played” edge 206 corresponds to an action performed by an external application (SPOTIFY) on an external audio file (the song “Imagine”). Although this disclosure describes particular edges 206 with particular attributes connecting user nodes 202 and concept nodes 204, this disclosure contemplates any suitable edges 206 with any suitable attributes connecting user nodes 202 and concept nodes 204. Moreover, although this disclosure describes edges between a user node 202 and a concept node 204 representing a single relationship, this disclosure contemplates edges between a user node 202 and a concept node 204 representing one or more relationships. As an example and not by way of limitation, an edge 206 may represent both that a user likes and has used at a particular concept. Alternatively, another edge 206 may represent each type of relationship (or multiples of a single relationship) between a user node 202 and a concept node 204 (as illustrated in FIG. 2 between user node 202 for user “E” and concept node 204 for “SPOTIFY”).

In particular embodiments, social-networking system 160 may create an edge 206 between a user node 202 and a concept node 204 in social graph 200. As an example and not by way of limitation, a user viewing a concept-profile page (such as, for example, by using a web browser or a special-purpose application hosted by the user's client system 130) may indicate that he or she likes the concept represented by the concept node 204 by clicking or selecting a “Like” icon, which may cause the user's client system 130 to send to social-networking system 160 a message indicating the user's liking of the concept associated with the concept-profile page. In response to the message, social-networking system 160 may create an edge 206 between user node 202 associated with the user and concept node 204, as illustrated by “like” edge 206 between the user and concept node 204. In particular embodiments, social-networking system 160 may store an edge 206 in one or more data stores. In particular embodiments, an edge 206 may be automatically formed by social-networking system 160 in response to a particular user action. As an example and not by way of limitation, if a first user uploads a picture, watches a movie, or listens to a song, an edge 206 may be formed between user node 202 corresponding to the first user and concept nodes 204 corresponding to those concepts. Although this disclosure describes forming particular edges 206 in particular manners, this disclosure contemplates forming any suitable edges 206 in any suitable manner.

In particular embodiments, information from social-networking system 160 and/or social graph 200 may be explicit, stated information or explicit connections of a user to a node, object, entity, brand, or page on social-networking system 160. In addition or as an alternative, information from social-networking system 160 and/or social graph 200 may be inferred information (which may include analyzing a user's history, demographic, social or other activities, friends' social or other activities, subscriptions, or any of the preceding of other users similar to the user (based, e.g., on shared interests, connections, or events)).

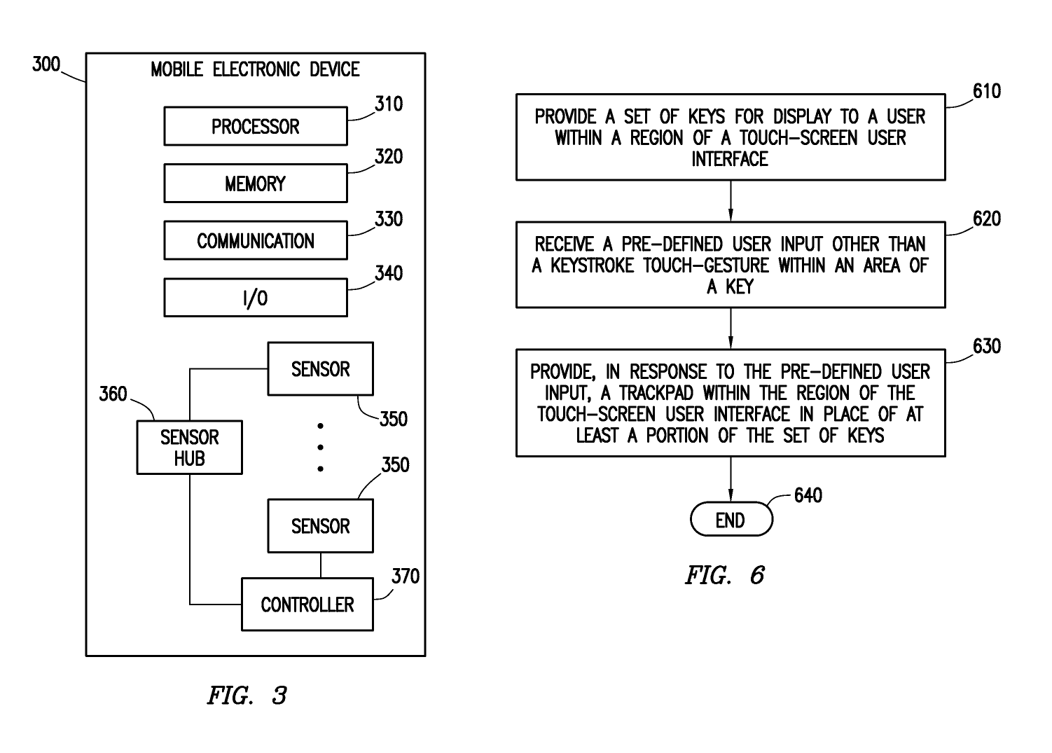

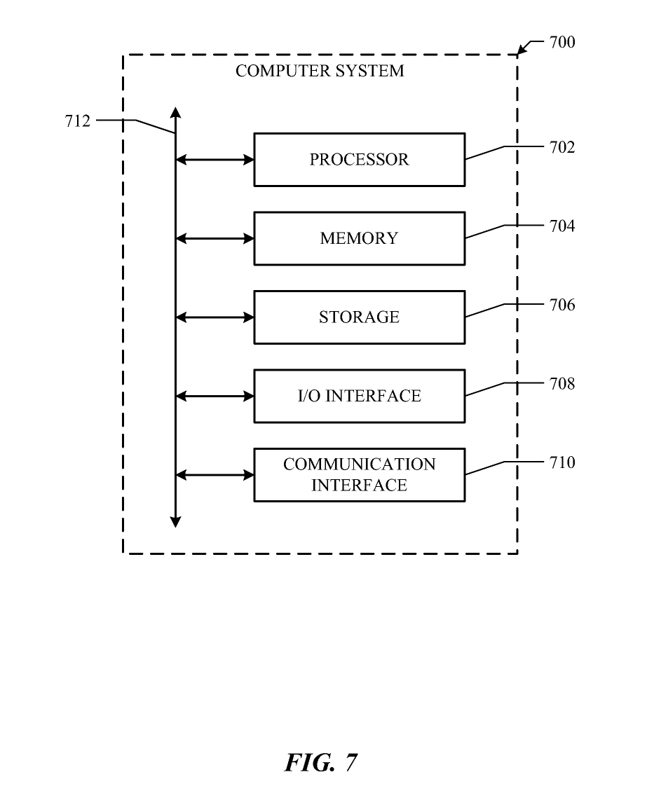

FIG. 3 illustrates an example personal computing device 300. In particular embodiments, personal computing device 300 may comprise a processor 310, a memory 320, a communication component 330 (e.g., antenna and communication interface for wireless communications), one or more input and/or output (I/O) components and/or interfaces 340, and one or more sensors 350. In particular embodiments, one or more I/O components and/or interfaces 340 may incorporate one or more sensors 350. In particular embodiments, personal computing device 300 may comprise a computer system or and element thereof as described in FIG. 7 and associated description. In particular embodiments, personal computing device 300 may be one example of a client system 130 of FIG. 1.

In particular embodiments, a personal computing device, such as a computing device, may include various types of sensors 350, such as, for example and without limitation: touch sensors (disposed, for example, on a display of the device, the back of the device and/or one or more lateral edges of the device) for detecting a user touching the surface of the mobile electronic device (e.g., using one or more fingers); accelerometer for detecting whether the personal computing device 300 is moving and the speed of the movement; thermometer for measuring the temperature change near the personal computing device 300; proximity sensor for detecting the proximity of the personal computing device 300 to another object (e.g., a hand, desk, or other object); light sensor for measuring the ambient light around the personal computing device 300; imaging sensor (e.g., camera) for capturing digital still images and/or video of objects near the personal computing device 300 (e.g., scenes, people, bar codes, QR codes, etc.); location sensors (e.g., Global Positioning System (GPS)) for determining the location (e.g., in terms of latitude and longitude) of the mobile electronic device; sensors for detecting communication networks within close proximity (e.g., near field communication (NFC), Bluetooth, RFID, infrared); chemical sensors; biometric sensors for biometrics-based (e.g., fingerprint, palm vein pattern, hand geometry, iris/retina, DNA, face, voice, olfactory, sweat) authentication of user of personal computing device 300; Gyrometer (for measuring the orientation of the personal computing device 300 along one or more axis); etc. This disclosure contemplates that a mobile electronic device may include any applicable type of sensor. Sensors may provide various types of sensor data, which may be analyzed to determine the user's intention with respect to the mobile electronic device at a given time.

In particular embodiments, a sensors hub 360 may optionally be included in personal computing device 300. Sensors 350 may be connected to sensors hub 360, which may be a low power-consuming processor that controls sensors 350, manages power for sensors 350, processes sensor inputs, aggregates sensor data, and performs certain sensor functions. In addition, in particular embodiments, some types of sensors 350 may be connected to a controller 370. In this case, sensors hub 360 may be connected to controller 370, which in turn is connected to sensor 350. Alternatively, in particular embodiments, there may be a sensor monitor in place of sensors hub 360 for managing sensors 350.

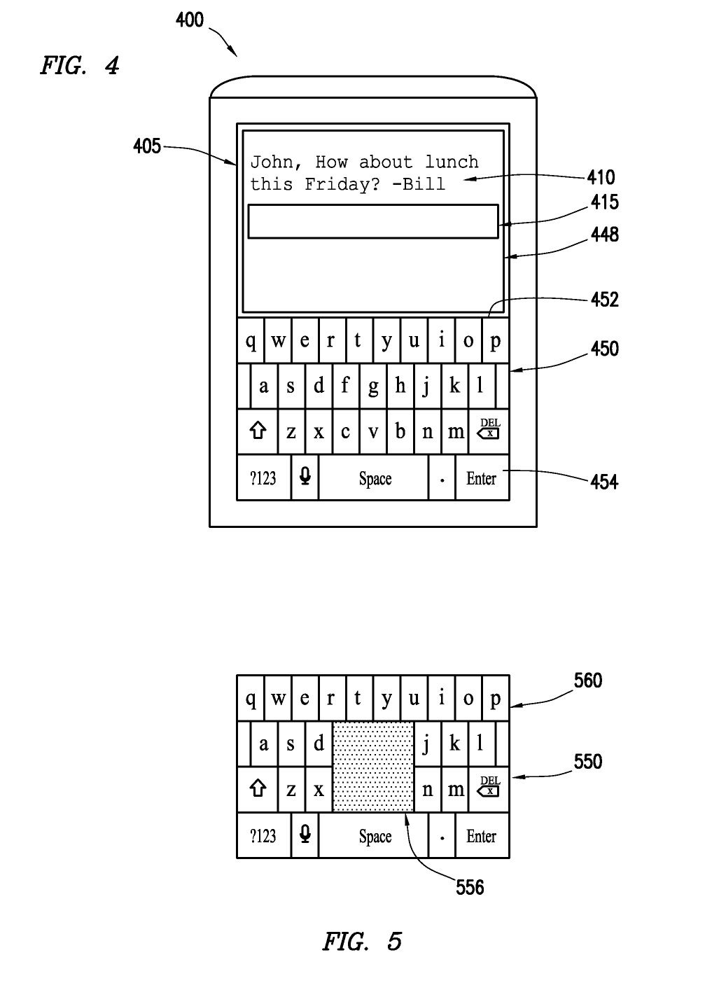

FIG. 4 illustrates an example scenario in which a user provides input to a personal computing device. FIG. 4 shows an example personal computing device 400. In particular embodiments, personal computing device 400 includes a touch screen 405. As shown in FIG. 4, a user may wish to use personal computing device 400 to communicate with one or more additional users (e.g., such as friends and/or family of the user). In order to do so, a user can tap on the screen (or input another appropriate indication) to unlock the device, browse to a webpage (or any other application that allows a communication session to occur), and open up an interface for communication. In particular embodiments, some inputs to personal computing device 400 can be performed by tapping or pressing on a certain region of the screen 405. For example, in FIG. 4, a user can select a message received from another user by tapping on message 410. By tapping on message 410, field 415 may be displayed on screen 405, allowing the user to communicate with the other user by inputting data into field 415. As shown in FIG. 4, to permit a user to input data into a field, for example, when a field is selected, the personal computing device 400 can display a virtual keyboard 450 on the touch screen 405. The user can input data by typing on the symbols of the virtual keyboard 450 to input corresponding letters, numbers, symbols, etc. For example, to input a letter “P” into a field, the user can tap the region of the touch screen 405 marked as a box marked with a letter “P” (i.e., the “P” key 452). Similarly, to input a line break or the completion of an entry, the user can tap the “Enter” key 454, marked as a box with the word “Enter.”

As is illustrated in FIG. 4, touch-screen 405 also includes a content portion 448. Content portion 448 may display content to a user, such as message 410, field 415, any other suitable content (such as a webpage, a map, a picture, etc.), or any combination of the preceding. Traditionally, a user has been able to provide various touch-gestures within content portion 448 in order to make changes to the content displayed in content portion 448. For example, when a map is being displayed in content portion 448, a user may be able to scroll (or otherwise navigate) to other portions of the map by providing a touch-gesture (e.g., tap, drag, swipe, pinch) in content portion 448. Unfortunately, a touch-gesture within content portion 448 may not always cause the desired result. As an example, when a user provides a swipe touch-gesture in content portion 448 (which is intended to cause a scrolling of content displayed in content portion 448), the motion may be interpreted as a selection gesture that causes a portion of the content to be selected (resulting in, for example, the display of a new webpage) as opposed to causing the intended scrolling of the content. Such unintended results of a touch-gesture in content portion 448 may be burdensome to the user.

According to one aspect of the disclosed subject matter, a personal computing device 400 can provide for display a trackpad 556 in virtual keyboard 550 (illustrated in FIG. 5), thereby allowing the user to change the content displayed in content portion 448 without providing a touch-gesture within content portion 448. In particular embodiments, personal computing device 400 may provide trackpad 556 for display in virtual keyboard 550 in response to a user providing a pre-defined user input at least partly within virtual keyboard 550. For example, in response to the user making a swipe touch-gesture within (or partly within) virtual keyboard 550, personal computing device 400 may provide trackpad 556 for display in place of one or more keys of virtual keyboard 550. As such, the user may then utilize trackpad 556 to change content displayed in content portion 448. The user may utilize trackpad 556 to cause any suitable change in the content. For example, the user may utilize the provided trackpad 556 (instead of content portion 448) to scroll through content displayed in content portion 448 (such as to scroll to a different area of a map), move a cursor (such as move a pointer cursor, a text cursor, or any other suitable cursor) to another portion of content portion 448 (such as to move a text cursor into the typed message “John, how about lunch this Friday?” so as to change it to read “John, how about dinner this Friday?”), add data to content portion 448 (such as to add a smiley face or another symbol to content portion 448), change the content displayed in content portion 448 in any other suitable manner, or any combination of the preceding.

While FIG. 5 illustrates a trackpad 556 as being provided for display in virtual keyboard 550, in particular embodiments, the trackpad 556 may be provided without being displayed in virtual keyboard 550. For example, although the trackpad 556 may be provided in place of the “f” key, the “g” key, the “h” key, the “c” key, the “v” key and the “b” key, each of these keys may still be displayed to the user. These keys, however, may now operate as a trackpad instead of individual keys.

FIG. 6 illustrates an exemplary method for providing a trackpad within a keyboard according to the disclosed subject matter. At step 610, a set of keys is provided for display to a user within a region of a touch-screen user interface. A set of keys may include any number of keys. For example, the set of keys may include two keys, three or more keys, or any other suitable number of keys. In particular embodiments, the set of keys may constitute all or part of a keyboard, such as, all or part of a QWERTY keyboard. In particular embodiments, the set of keys may correspond to a set of symbols. For example, the set of keys may correspond to alphabetical symbols, alphanumeric characters, acronyms, logograms, pictograms, ideograms, mathematical symbols, typographical symbols, images, any other symbols, or any combination of the preceding.

In particular embodiments, each key may be responsive to a keystroke touch-gesture. For example, in order for a user to input the symbol corresponding to a key (such as, for example, the “p” symbol corresponding to the “p” key), the user may provide a keystroke touch-gesture on touch-screen 405 in an area corresponding to that key, such as area 560 (which corresponds to the “p” key). In particular embodiments, a keystroke touch-gesture may include any touch-gesture that indicates that the user intends to input a symbol corresponding a particular key, such as a tapping (or a pressing) gesture within the area of a particular key.

At step 620, a pre-defined user input other than a keystroke touch-gesture within an area of a key is received. In particular embodiments, such a pre-defined user input may include any input that does not indicate that the user intends to input a symbol corresponding a particular key. For example, such a pre-defined user input may include a swiping gesture, a dragging gesture, a pinching gesture, a gesture that includes the user touching more than one of the keys in the set of keys at the same time or approximately the same time (such as the user pressing the “q” key, the “w” key, and the “e” key at the same time or at approximately the same time (such as within a range of time that indicates that the user is not intending to input two or more different symbols)), a gesture that changes the orientation of the personal computing device (such as turning the personal computing device from a vertical orientation to a horizontal orientation, rotating the personal computing device, making a gesture with the personal computing device, etc.), any other pre-defined user input that does not indicate that a user intends to input a symbol corresponding to a particular key, or any combination of the preceding.

In particular embodiments, the pre-defined user input other than a keystroke touch-gesture within an area of a key may include a user input that occurs at least partly within the region of the touch-screen user interface. For example, such a pre-defined user input may include a swiping gesture that begins in content portion 448, but that ends in virtual keyboard 550 (or vice versa). In particular embodiments, the pre-defined user input other than a keystroke touch-gesture within an area of a key may not include the user merely tapping (or pressing) a single key, or any other touch-gesture that may be determined by personal computing device 400 to be the user's attempt to input a symbol corresponding to a particular key. In particular embodiments, the velocity of a touch-gesture may be utilized to determine that the user is not intending to input a symbol corresponding to a particular key. For example, in particular embodiments, a user may utilize particular swiping motions to enter symbols corresponding to keys. The velocity of such motions, however, may be low (because the user may stop the motion at a particular key). As such, if the swiping motion has a higher velocity (which is indicative of a user making a random swiping motion), the swiping motion may be determined to not be a keystroke touch-gesture.

In particular embodiments, the user input may be pre-defined in any suitable manner. For example, a user of personal computing device 400 may define the user input prior to using it to cause the trackpad 556 to be provided. In such an example, the user may pre-define a particular swipe touch gesture as the pre-defined user input. As another example, the user input may be pre-defined by a manufacturer and/or developer of personal computing device 400. In such an example, the user may be able to change the default user input set by the manufacturer and/or developer.

At step 630, in response to the pre-defined user input, a trackpad is provided within the region of the touch-screen user interface in place of at least a portion of the set of keys. A trackpad may include any input device that translates a motion and/or position of a user's finger (or other object) to a relative position on the touch-screen. For example, if the user touches the trackpad and moves their finger upward, content being viewed in content portion 448 may scroll up (or vice versa). As a further example, if a user taps (or presses) the trackpad with a finger (or other object), particular content being viewed in content portion 448 may be selected (causing, for example, a webpage associated with that content to be displayed). In particular embodiments, the trackpad may translate the motion and/or position of a user's finger (or other object) to an object, such as a cursor displayed in content portion 448. For example, if a user moves their finger on the trackpad, a pointer cursor may replicate such movement in content portion 448. In particular embodiments, the trackpad may also allow a user to input data. For example, the user may draw a circle on the trackpad, resulting in a smiley face being input into the content portion. In such an example, a user, manufacturer, and/or developer may define various inputs to correspond to various symbols (i.e., the user may define a circle drawn clockwise on the trackpad to correspond to a yellow smiley face and further define a circle drawn counter-clockwise to correspond to a red frowny face). As another example, the user may draw a symbol (such as the symbol “A”), resulting in the symbol “A” being input into the content portion. As a further example, the user may write one or more words on the trackpad, resulting in the words being input into the content portion. As a further example, the user may sign their name on the trackpad, resulting in their signature being input into the content portion.

In particular embodiments, the trackpad may not operate as a trackpad until after it has been provided. For example, although the pre-defined user input may cause the trackpad to be provided, the pre-defined user input may not translate that particular motion and/or position of the user's finger (or other object) to a relative position on the touch-screen. Instead, the trackpad may translate subsequent motions and/or positions of the user's finger (or other object) to a relative position on the touch-screen. On the other hand, in particular embodiments, the trackpad may operate as a trackpad at approximately the same time it is provided. For example, not only may the pre-defined user input cause the trackpad to be provided, but the trackpad may also translate that particular motion and/or position of the user's finger (or other object) to a relative position on the touch-screen. In such an example, a scrolling motion by the user's finger within an area of a key may both provide the trackpad and cause the content being viewed in content portion 448 to scroll. Furthermore, drawing a circle within an area of a key may both provide the trackpad and cause a smiley face to be input into the content portion.

As is discussed above, the trackpad may be provided in place of at least a portion of the set of keys. For example, the trackpad may be provided in place of the “f” key, the “g” key, the “h” key, the “c” key, the “v” key and the “b” key of a QWERTY keyboard. As such, instead of these keys operating as individual keys that input their corresponding symbols, these keys may operate together as a trackpad. In particular embodiments, the trackpad may be provided in place of any suitable keys. For example, although the trackpad has been described above as being provided in place of the “f” key, the “g” key, the “h” key, the “c” key, the “v” key and the “b” key of a QWERTY keyboard, the trackpad may be provided in place of any other key(s) of any type of keyboard. As another example, the trackpad may be provided in place of all of the set of keys. In such an example, all of the set of keys may operate as a trackpad.

In particular embodiments, the provided trackpad may not be displayed. For example, even though the trackpad may be provided in place of the “f” key, the “g” key, the “h” key, the “c” key, the “v” key and the “b” key, each of these keys may still be displayed to the user (such as is illustrated in FIG. 4). These keys, however, may now operate as a trackpad instead of individual keys. In particular embodiments, the provided trackpad may be displayed to the user. For example, as is illustrated in FIG. 5, trackpad 556 may be displayed to the user. The trackpad may be displayed in any suitable manner. For example, the trackpad may be displayed as any suitable graphical representation, such as a blank screen, a knob icon, a slider icon, any other icon that may be associated with a trackpad, or any combination of the preceding. As other examples, the trackpad may have any suitable size, suitable shape, suitable position in the keyboard, or any combination of the preceding. Furthermore, in particular embodiments, a user may be able to change any setting associated with the trackpad. For example, the user may be able to change the graphical representation of the trackpad (such as change it to a big smiley face), change the size of the trackpad, change the shape of the trackpad, change the position of the trackpad in the keyboard, change which keys are replaced by the trackpad, change the sensitivity of the trackpad, change any other suitable setting, or any combination of the preceding.

In particular embodiments, while the trackpad is being provided within the region of the touch-screen user interface, the user may be prevented from utilizing any of the set of keys to input symbols corresponding to the keys. For example, while trackpad 556 is provided in virtual keyboard 550, the user may be unable to input any of the symbols, such as, for example, the “q” symbol or the “e” symbol by tapping (or otherwise pressing) the keys associated with those symbols. In particular embodiments, although the user may be prevented from inputting the symbols by touching (or otherwise pressing) the keys corresponding to those symbols, the user may be able to enter the symbols in another manner, such as speaking the symbols, drawing the symbols on touch-screen 405 (in content portion 448, virtual keyboard 550, trackpad 556, or any combination of the preceding), any other manner of inputting the symbols without touching the keys, or any combination of the preceding.

After the trackpad has been provided within the region of the touch-screen user interface, the method moves to step 640. At step 640, the method ends.

While the method of FIG. 6 is illustrated as ending at step 640, in particular embodiments, the method of FIG. 6 may include additional steps. For example, in particular embodiments, the method of FIG. 6 may further include steps for removing the trackpad once it is no longer needed (or desired) by the user. In such an example, the method of FIG. 6 may further include receiving a second pre-defined user input, and in response to the second predefined user input, providing within the region of the touch-screen user interface, the at least a portion of the set of keys in place of the trackpad. In particular embodiments, the trackpad may be replaced by the same keys that were originally replaced by the trackpad (discussed above). For example, as is illustrated in FIG. 5, trackpad 556 may have originally replaced the “f” key, the “g” key, the “h” key, the “c” key, the “v” key and the “b” key. In such an example, when the second pre-defined user input is received, the “f” key, the “g” key, the “h” key, the “c” key, the “v” key and the “b” key may now replace the trackpad 556. In particular embodiments, the second pre-defined user input may include any suitable input that indicates that the user intends the trackpad to be removed from the keyboard, such as a keystroke touch-gesture within the region of the touch-screen user interface. For example, the second pre-defined user input may include the user tapping (or otherwise pressing) the “q” key. In particular embodiments, such an input may cause the trackpad to be replaced. Furthermore, in particular embodiments, not only may the second pre-defined user input cause the trackpad to be replaced, but it may also allow a user to utilize the keys to input the symbols corresponding to the keys. For example, once the trackpad is replaced, any of the keys may be once again utilized by the user to input symbols.

Particular embodiments may repeat one or more steps of the method of FIG. 6, where appropriate. Although this disclosure describes and illustrates particular steps of the method of FIG. 6 as occurring in a particular order, this disclosure contemplates any suitable steps of the method of FIG. 6 occurring in any suitable order. Moreover, although this disclosure describes and illustrates particular components, devices, or systems carrying out particular steps of the method of FIG. 6, this disclosure contemplates any suitable combination of any suitable components, devices, or systems carrying out any suitable steps of the method of FIG. 6.

FIG. 7 illustrates an example computer system 700. In particular embodiments, one or more computer systems 700 perform one or more steps of one or more methods described or illustrated herein. In particular embodiments, one or more computer systems 700 provide functionality described or illustrated herein. In particular embodiments, software running on one or more computer systems 700 performs one or more steps of one or more methods described or illustrated herein or provides functionality described or illustrated herein. Particular embodiments include one or more portions of one or more computer systems 700. Herein, reference to a computer system may encompass a computing device, and vice versa, where appropriate. Moreover, reference to a computer system may encompass one or more computer systems, where appropriate.

This disclosure contemplates any suitable number of computer systems 700. This disclosure contemplates computer system 700 taking any suitable physical form. As example and not by way of limitation, computer system 700 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 700 may include one or more computer systems 700; be unitary or distributed; span multiple locations; span multiple machines; span multiple data centers; or reside in a cloud, which may include one or more cloud components in one or more networks. Where appropriate, one or more computer systems 700 may perform without substantial spatial or temporal limitation one or more steps of one or more methods described or illustrated herein. As an example and not by way of limitation, one or more computer systems 700 may perform in real time or in batch mode one or more steps of one or more methods described or illustrated herein. One or more computer systems 700 may perform at different times or at different locations one or more steps of one or more methods described or illustrated herein, where appropriate.

In particular embodiments, computer system 700 includes a processor 702, memory 704, storage 706, an input/output (I/O) interface 708, a communication interface 710, and a bus 712. Although this disclosure describes and illustrates a particular computer system having a particular number of particular components in a particular arrangement, this disclosure contemplates any suitable computer system having any suitable number of any suitable components in any suitable arrangement.

In particular embodiments, processor 702 includes hardware for executing instructions, such as those making up a computer program. As an example and not by way of limitation, to execute instructions, processor 702 may retrieve (or fetch) the instructions from an internal register, an internal cache, memory 704, or storage 706; decode and execute them; and then write one or more results to an internal register, an internal cache, memory 704, or storage 706. In particular embodiments, processor 702 may include one or more internal caches for data, instructions, or addresses. This disclosure contemplates processor 702 including any suitable number of any suitable internal caches, where appropriate. As an example and not by way of limitation, processor 702 may include one or more instruction caches, one or more data caches, and one or more translation lookaside buffers (TLBs). Instructions in the instruction caches may be copies of instructions in memory 704 or storage 706, and the instruction caches may speed up retrieval of those instructions by processor 702. Data in the data caches may be copies of data in memory 704 or storage 706 for instructions executing at processor 702 to operate on; the results of previous instructions executed at processor 702 for access by subsequent instructions executing at processor 702 or for writing to memory 704 or storage 706; or other suitable data. The data caches may speed up read or write operations by processor 702. The TLBs may speed up virtual-address translation for processor 702. In particular embodiments, processor 702 may include one or more internal registers for data, instructions, or addresses. This disclosure contemplates processor 702 including any suitable number of any suitable internal registers, where appropriate. Where appropriate, processor 702 may include one or more arithmetic logic units (ALUs); be a multi-core processor; or include one or more processors 702. Although this disclosure describes and illustrates a particular processor, this disclosure contemplates any suitable processor.

In particular embodiments, memory 704 includes main memory for storing instructions for processor 702 to execute or data for processor 702 to operate on. As an example and not by way of limitation, computer system 700 may load instructions from storage 706 or another source (such as, for example, another computer system 700) to memory 704. Processor 702 may then load the instructions from memory 704 to an internal register or internal cache. To execute the instructions, processor 702 may retrieve the instructions from the internal register or internal cache and decode them. During or after execution of the instructions, processor 702 may write one or more results (which may be intermediate or final results) to the internal register or internal cache. Processor 702 may then write one or more of those results to memory 704. In particular embodiments, processor 702 executes only instructions in one or more internal registers or internal caches or in memory 704 (as opposed to storage 706 or elsewhere) and operates only on data in one or more internal registers or internal caches or in memory 704 (as opposed to storage 706 or elsewhere). One or more memory buses (which may each include an address bus and a data bus) may couple processor 702 to memory 704. Bus 712 may include one or more memory buses, as described below. In particular embodiments, one or more memory management units (MMUs) reside between processor 702 and memory 704 and facilitate accesses to memory 704 requested by processor 702. In particular embodiments, memory 704 includes random access memory (RAM). This RAM may be volatile memory, where appropriate Where appropriate, this RAM may be dynamic RAM (DRAM) or static RAM (SRAM). Moreover, where appropriate, this RAM may be single-ported or multi-ported RAM. This disclosure contemplates any suitable RAM. Memory 704 may include one or more memories 704, where appropriate. Although this disclosure describes and illustrates particular memory, this disclosure contemplates any suitable memory.

In particular embodiments, storage 706 includes mass storage for data or instructions. As an example and not by way of limitation, storage 706 may include a hard disk drive (HDD), a floppy disk drive, flash memory, an optical disc, a magneto-optical disc, magnetic tape, or a Universal Serial Bus (USB) drive or a combination of two or more of these. Storage 706 may include removable or non-removable (or fixed) media, where appropriate. Storage 706 may be internal or external to computer system 700, where appropriate. In particular embodiments, storage 706 is non-volatile, solid-state memory. In particular embodiments, storage 706 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 706 taking any suitable physical form. Storage 706 may include one or more storage control units facilitating communication between processor 702 and storage 706, where appropriate. Where appropriate, storage 706 may include one or more storages 706. Although this disclosure describes and illustrates particular storage, this disclosure contemplates any suitable storage.

In particular embodiments, I/O interface 708 includes hardware, software, or both, providing one or more interfaces for communication between computer system 700 and one or more I/O devices. Computer system 700 may include one or more of these I/O devices, where appropriate. One or more of these I/O devices may enable communication between a person and computer system 700. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 708 for them. Where appropriate, I/O interface 708 may include one or more device or software drivers enabling processor 702 to drive one or more of these I/O devices. I/O interface 708 may include one or more I/O interfaces 708, where appropriate. Although this disclosure describes and illustrates a particular I/O interface, this disclosure contemplates any suitable I/O interface.

In particular embodiments, communication interface 710 includes hardware, software, or both providing one or more interfaces for communication (such as, for example, packet-based communication) between computer system 700 and one or more other computer systems 700 or one or more networks. As an example and not by way of limitation, communication interface 710 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 710 for it. As an example and not by way of limitation, computer system 700 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 700 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 700 may include any suitable communication interface 710 for any of these networks, where appropriate. Communication interface 710 may include one or more communication interfaces 710, where appropriate. Although this disclosure describes and illustrates a particular communication interface, this disclosure contemplates any suitable communication interface.

In particular embodiments, bus 712 includes hardware, software, or both coupling components of computer system 700 to each other. As an example and not by way of limitation, bus 712 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 712 may include one or more buses 712, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, functions, operations, or steps, any of these embodiments may include any combination or permutation of any of the components, elements, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative.

What is claimed is:

1. A method comprising:
by a computing device, providing for display to a user a set of keys within a region of a touch-screen user interface, each key being responsive to a keystroke touch-gesture within an area of the key;
by the computing device, receiving a pre-defined user input other than a keystroke touch-gesture within an area of a key; and
by the computing device, in response to the pre-defined user input, providing within the region of the touch-screen user interface a trackpad in place of at least a portion of the set of keys.

2. The method of claim 1, wherein the pre-defined user input comprises a pre-defined swipe touch-gesture at least partly within the region of the touch-screen user interface.

3. The method of claim 1, wherein:
the trackpad is provided for display; and
the display of the trackpad comprises:
a blank screen;
a knob icon; or
a slider icon.

4. The method of claim 1, wherein the trackpad is provided for user interaction without being displayed.

5. The method of claim 1, wherein the user is unable to utilize any of the set of keys to input any symbols corresponding to the set of keys while the trackpad is provided within the region of the touch-screen user interface.

6. The method of claim 1, further comprising:
by the computing device, receiving a second pre-defined user input; and
by the computing device, in response to the second pre-defined user input, providing within the region of the touch-screen user interface the at least a portion of the set of keys in place of the trackpad.

7. The method of claim 6, wherein the second pre-defined user input comprises a keystroke touch-gesture within the region of the touch-screen user interface.

8. The method of claim 1, wherein the set of keys constitute a QWERTY keyboard.

9. One or more computer-readable non-transitory storage media embodying software that is operable when executed to:
provide for display to a user a set of keys within a region of a touch-screen user interface, each key being responsive to a keystroke touch-gesture within an area of the key;
receive a pre-defined user input other than a keystroke touch-gesture within an area of a key; and
in response to the pre-defined user input, provide within the region of the touch-screen user interface a trackpad in place of at least a portion of the set of keys.

10. The media of claim 9, wherein the pre-defined user input comprises a pre-defined swipe touch-gesture at least partly within the region of the touch-screen user interface.

11. The media of claim 9, wherein:
the trackpad is provided for display; and
the display of the trackpad comprises:
a blank screen;
a knob icon; or
a slider icon.

12. The media of claim 9, wherein the trackpad is provided for user interaction without being displayed.

13. The media of claim 9, wherein the user is unable to utilize any of the set of keys to input any symbols corresponding to the set of keys while the trackpad is provided within the region of the touch-screen user interface.

14. The media of claim 9, wherein the software is further operable when executed to:
receive a second pre-defined user input; and
in response to the second pre-defined user input, provide within the region of the touch-screen user interface the at least a portion of the set of keys in place of the trackpad.

15. A system comprising:
one or more processors; and
a memory coupled to the processors comprising instructions executable by the processors, the processors operable when executing the instructions to:
provide for display to a user a set of keys within a region of a touch-screen user interface, each key being responsive to a keystroke touch-gesture within an area of the key;
receive a pre-defined user input other than a keystroke touch-gesture within an area of a key; and
in response to the pre-defined user input, provide within the region of the touch-screen user interface a trackpad in place of at least a portion of the set of keys.

16. The system of claim 15, wherein the pre-defined user input comprises a pre-defined swipe touch-gesture at least partly within the region of the touch-screen user interface.

17. The system of claim 15, wherein:
the trackpad is provided for display; and
the display of the trackpad comprises:
a blank screen;
a knob icon; or
a slider icon.

18. The system of claim 15, wherein the trackpad is provided for user interaction without being displayed.

19. The system of claim 15, wherein the user is unable to utilize any of the set of keys to input any symbols corresponding to the set of keys while the trackpad is provided within the region of the touch-screen user interface.

20. The system of claim 15, wherein the processors are further operable when executing the instructions to:
receive a second pre-defined user input; and
in response to the second pre-defined user input, provide within the region of the touch-screen user interface the at least a portion of the set of keys in place of the trackpad.
